(19) United States
(12) Patent Application Publication
(10) Pub. No.: US 2026/0297985 A1
(43) Pub. Date: Oct. 1, 2026

(54) VEHICLE HOOD LATCH WITH ACTIVE PEDESTRIAN PROTECTION

(71) Applicant: MAGNA CLOSURES INC., Newmarket (CA)

(72) Inventor: Thomas KLEIN, Newmarket (CA)

(21) Appl. No.: 19/571,220

(22) Filed: Mar. 18, 2026

Related U.S. Application Data
(60) Provisional application No. 63/778,455, filed on Mar. 27, 2025.

(51) Int. Cl. E05B 77/08; E05B 83/24

(52) U.S. Cl. CPC E05B 77/08; E05B 83/24

(57) ABSTRACT

A latch for a closure panel of a motor vehicle includes a ratchet moveable between a primary striker capture position, a secondary striker capture position, and a striker release position. At least two pawls are aligned with the ratchet to prevent the ratchet from moving to a striker release position, wherein the pawls are moveable away together from the ratchet during an active pedestrian mode of the latch to allow the ratchet to move to an active pedestrian protection position.

### CROSS-REFERENCE TO RELATED APPLICATIONS

This application claims the benefit of U.S. Provisional Application Serial No. 63/778,455, filed Mar. 27, 2025, which is incorporated herein by reference in its entirety.

### FIELD

The present disclosure relates to latch assemblies for motor vehicles, and more particularly, to hood latch assemblies for motor vehicles.

### BACKGROUND

Latches for vehicle front hoods, whether for front engine hoods or front trunk hoods also known as frunks, are typically actuated in two stages. During a first stage a first release device, such as a handle, is actuated from inside the passenger compartment of the vehicle which moves the latch from a primary closed position to secondary closed position, wherein the latch is partially released, but still retains a striker of the hood to keep the hood from being fully opened. To release the latch completely the vehicle occupant typically must exit the vehicle and actuate a second release device, such as a lever, that is under the hood. This may be inconvenient in some situations.

Double-pull release latches for vehicle hoods are also known, which allows a user to pull twice on the hood release handle located inside the passenger compartment of the vehicle to cause the latch to both transition from the primary closed position to the secondary closed position upon the first pull, and then to fully release the latch from the secondary closed position to a fully open position upon the second pull. One drawback of such a double-pull release latch for a vehicle hood is that the user may unintentionally release the hood, which can be particularly problematic if the hood is a front hood that is caused to open while the vehicle is moving. Further yet, if the hood is for a front trunk compartment, the double pull latch is typically only actuatable from inside the passenger compartment, and thus, if a person were to become locked and entrapped inside the front trunk compartment, the entrapped person would be unable to open the front hood.

Desired is a latch which can be unlatched in a multiple stage release actuations from inside of the passenger compartment of the vehicle when intended, such as while the vehicle is not moving, and wherein the latch is prevented from being fully released to an open position while the vehicle is traveling in excess of a predetermined speed and/or while the engine is running and/or other vehicle state. Further, it is desired to integrate an auxiliary mechanism into the multiple stage release hood latch that allows a person to release the latch from within a stowage compartment, including the front trunk compartment. It is further desired to configure the auxiliary latch mechanism to allow the latch to be fully released while the vehicle is not moving or traveling below a predetermined speed and/or while the engine is not on and/or other vehicle state, and to allow the latch to move from the primary closed position to the secondary closed position when the vehicle is moving in excess of the predetermined speed and/or while the engine is on and/or other vehicle state, but not to the fully open position.

### SUMMARY

This section provides a general summary of the present disclosure and is not a comprehensive disclosure of its full scope or all of its features, aspects and objectives.

In accordance with one aspect of the disclosure, a latch for a closure panel of a motor vehicle includes a ratchet moveable between a primary striker capture position, a secondary striker capture position, and a striker release position; and at least two pawls aligned with the ratchet to prevent the ratchet from moving to a striker release position, wherein the pawls are moveable away together from the ratchet during an active pedestrian mode of the latch to allow the ratchet to move to an active pedestrian protection position.

In accordance with one aspect of the disclosure, the at least two pawls includes a primary pawl configured to hold the ratchet in the primary striker capture position, and a secondary pawl configured to hold the ratchet in the secondary striker capture position, wherein the primary pawl and the secondary pawl are moveable away together from the ratchet.

In accordance with one aspect of the disclosure, the at least two pawls includes three pawls.

In accordance with one aspect of the disclosure, the at least two pawls includes a primary pawl configured to hold the ratchet in the primary striker capture position, and a cinching pawl configured to move the ratchet from the secondary striker capture position to the primary striker capture position, wherein the primary pawl and the cinching pawl are movable away together from the ratchet by moving a common release lever during the active pedestrian mode of the latch.

In accordance with one aspect of the disclosure, the common release lever is an emergency release lever located within a compartment the closure panel closes off.

In accordance with one aspect of the disclosure, the compartment is a front trunk of a vehicle, and the emergency release lever is accessible from within the front trunk.

In accordance with one aspect of the disclosure, the latch further includes a moveable lever activated by an actuator to cause the at least two pawls to move together to release the ratchet.

In accordance with one aspect of the disclosure, the moveable lever is a slider adapted to directly move a secondary pawl, and directly move an emergency release lever that directly causes movement of a primary pawl and a cinching pawl.

In accordance with one aspect of the disclosure, the slider is configured to move a lift lever to facilitate moving the closure panel to a pedestrian protection pop-up position.

In accordance with one aspect of the disclosure, the slider is provided on one side of a frame plate of the latch, and the release lever is provided on the other side of the frame plate, wherein the slider and the release lever are operably coupled to each other via a lug extending through an aperture in the frame plate.

In accordance with one aspect of the disclosure, the at least two pawls includes a primary pawl to hold the ratchet in the primary striker capture position, a secondary pawl to hold the ratchet in the secondary striker capture position, and a cinching pawl that is moveable to engage and move the ratchet from the secondary striker capture position to the primary striker capture position.

### BRIEF DESCRIPTION OF THE DRAWINGS

Other advantages of the present disclosure will be readily appreciated, as the same becomes better understood by reference to the following detailed description when considered in connection with the accompanying drawings wherein:

FIG. 1 is a side view of an embodiment of a latch assembly shown in a fully latched position and provided with an auxiliary release lever, constructed in accordance with an aspect of the present disclosure;

FIG. 2 is a side view of the latch assembly of FIG. 1 shown in a fully latched position and provided with an active pedestrian protection mechanism, constructed in accordance with another aspect of the present disclosure; and

FIG. 2A is an enlarged perspective view of the latch assembly of FIG. 2 illustrating another embodiment of an active pedestrian protection mechanism, constructed according to another aspect of the present disclosure.

### DETAILED DESCRIPTION OF EXAMPLE EMBODIMENTS

Example embodiments of a power-operated pedestrian protection system for use with a closure latch assembly of a closure latch system of a motor vehicle will now be described more fully with reference to the accompanying drawings. To this end, the example embodiments of the closure latch system and closure latch assembly are provided so that the disclosure will be thorough and will fully convey its intended scope to those who are skilled in the art. Accordingly, numerous specific details are set forth such as examples of specific components, devices, and methods, to provide a thorough understanding of particular embodiments of the present disclosure. However, it will be apparent to those skilled in the art that specific details need not be employed, that the example embodiments may be embodied in many different forms, and that the example embodiments should not be construed to limit the scope of the present disclosure. In some parts of the example embodiments, well-known processes, well-known device structures, and well-known technologies are not described in detail.

In the following detailed description, the expression “closure latch assembly” will be used to generally indicate any power-operated latch device adapted for use with a vehicle closure panel and which is configured to provide at least one of a power cinch feature and a power release feature. Additionally, the expression “closure panel” will be used to indicate any element mounted to a structural body portion of a motor vehicle and which is moveable between a fully-open position and a fully-closed position, respectively opening and closing an access to a passenger or storage compartment of the motor vehicle. Without limitations, closure panel herein is described in relation to front hoods of motor vehicles.

The terminology used herein is for the purpose of describing particular example embodiments only and is not intended to be limiting. As used herein, the singular forms "a," "an," and "the" may be intended to include the plural forms as well, unless the context clearly indicates otherwise. The terms "compromises," "comprising," "including," and "having," are inclusive and therefore specify the presence of stated features, integers, steps, operations, elements, and/or components, but do not preclude the presence or addition of one or more other features, integers, steps, operations, elements, and/or components, and/or groups thereof. The method steps, processes, and operations described herein are no to be construed as necessarily requiring their performance in the particular order discussed or illustrated, unless specifically identified as an order of performance. It is also to be understood that additional or alternative steps may be employed.

When an element or layer is referred to as being "on," "engaged to," "connected to," or "coupled to" another element or layer, it may be directly on, engaged, connected or coupled to the other element or layer, or intervening elements or layers may be present. In contrast, when an element is referred to as being "directly on," directly engaged to," "directly connected to," or "directly coupled to" another element or layer, there may be no intervening elements or layers present. Other words used to describe the relationship between elements should be interpreted in a like fashion (e.g., "between" versus "directly between," "adjacent" versus "directly adjacent," etc.). As used herein, the term "and/or" includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as "first," "second," and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as "inner," "outer," "beneath," "below," "lower," "above," "upper," and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as "below" or "beneath" other elements or features would then be oriented "above" the other elements or features. Thus, the example term "below" can encompass both an orientation of above and below. The device may be otherwise oriented (rotated 90 degrees or at other orientations) and the spatially relative descriptors used herein interpreted accordingly.

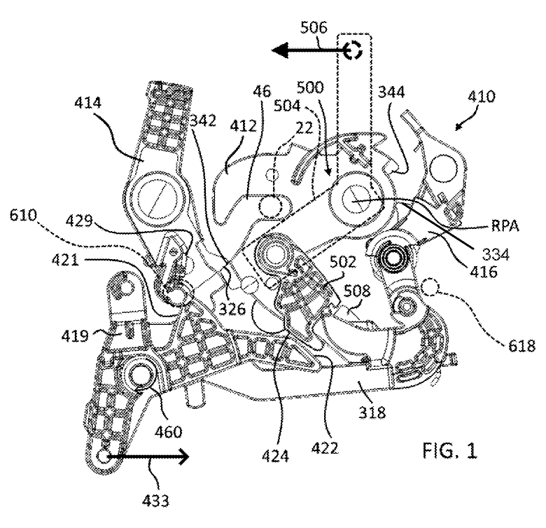

Now, referring in more detail to the drawings, in FIG. 1, there is illustrated a non-limiting embodiment of a cinching latch for a closure panel of a motor vehicle, such as a trunk lid or a front trunk (frunk) lid, by way of example and without limitation, with cinching latch also referred to as latch 410. A frunk compartment is illustratively shown and described in United States Patent Publication No. US20250289290A1, the entire contents of which is incorporated herein by reference. Latch 410 has a cinching mechanism 500 for moving a ratchet 412 from a secondary closed position, also referred to as secondary striker capture position, to a primary closed position, also referred to as primary striker capture position, as shown in FIG. 1, whereat a primary pawl 414 holds the ratchet 412, when a primary locking surface 326 of primary pawl 414 engages with primary locking surface 342 of ratchet 412, in the primary striker capture position, and whereat the closure panel is maintained in a fully closed position. Cinching mechanism 500 includes a cinching pawl 502 pivotally mounted to a cinching lever 504. Cinching lever 504 is driven for rotation about an axis shown as being coaxial with the ratchet pivot axis RPA when rotated by an actuator, such as a cable 506. Cinching pawl 502 is biased into alignment with a ratchet lug 508 fixed to ratchet 412 by a bias member 510 and can be moved out of alignment from the ratchet lug 508 against the bias member 510, wherein the bias member 510 can be provided as any suitable spring, such as a coil spring, by way of example and without limitation, acting between the cinching lever 504 and the cinching pawl 502.

Latch 410 further includes an emergency release lever, also referred to as auxiliary release lever 419, in accordance with another aspect of the disclosure. The auxiliary release lever 419 is generally operable upon actuation via a cable 433, for example. Cable 433, upon being actuated, moves auxiliary release lever 419 against bias imparted by an auxiliary release lever biasing member, such as a torsion spring 460 shown disposed about a pivot axis of auxiliary release lever 419, by way of example and without limitation, for selective actuation of the latch 410 from within a stowage compartment, e.g. trunk or frunk, or from outside the vehicle, for example. Upon actuation of the auxiliary release lever 419, a first drive surface of auxiliary release lever 419 will be brought into contact with the primary pawl 414 to misalign the primary locking surface 326 from the primary locking surface 342, and a second drive surface 422 of auxiliary release lever 419 will contact a cinching pawl surface 424 to misalign the cinching pawl 502 from the ratchet lug 508 to allow the ratchet 412 to move away from the primary striker capture position without being blocked by both the primary pawl 414 and the cinching pawl 502. The ratchet 412 will move away from the primary striker capture position until a secondary locking surface 344 of ratchet 412 enters into engagement with a secondary locking surface 334 of secondary pawl 416 to hold the ratchet 412 in the secondary striker capture position after the actuation of cable 433. It is to be understood that secondary pawl 416 can be moved out from engagement with secondary locking surface 334 during a normal release operation to allow ratchet 412 to move to a striker release position (not shown), whereat striker 22 can be release from ratchet 412 to allow the closure panel to be moved to a fully open position. As the auxiliary release lever 419 is not configured to interact with the coupling lever 318 to couple the primary pawl 414 motion with the secondary pawl 416, the latch 410 will not be fully released upon actuation of the auxiliary release lever 419, but rather, will only be moved to a secondary latched position, whereat the secondary locking surface 334 of secondary pawl 416 is locked in engagement with the secondary lock surface 344 of ratchet 412, and whereat the closure panel is releasably maintained in a partially open position, thereby allowing air into the stowage compartment.

In an active pedestrian event where the hood of the motor vehicle is required to be moved from a fully closed position corresponding to a primary closed position of latch 410 in FIG. 1, to a raised active pedestrian position, also referred to as partially open pop-up position during an active pedestrian event, the ratchet 412 may be required to rotate past the secondary striker capture position to allow the striker 22, captured in a ratchet slot, referred to hereafter as slot 46, to be raised to the active pedestrian position that is elevated above the secondary latched position. Accordingly, the secondary pawl 416 needs to be acted on to allow the ratchet 412 to move past the secondary striker capture position. However, since the auxiliary release lever 419 does not interact with the coupling lever 318 to couple the primary pawl 414 motion with the secondary pawl 416 during activation of the auxiliary release lever 419 by cable 433, the secondary pawl 416 will not allow the striker 22 captured in the slot 46 to be raised to an active pedestrian position beyond a secondary release position. Furthermore, an active pyrotechnic device, or other type of actuator, may be required to provide a rapid release of energy to release the latch 410, as well as to provide the energy needed to raise the hood, which cable 433 may not be able to provide.

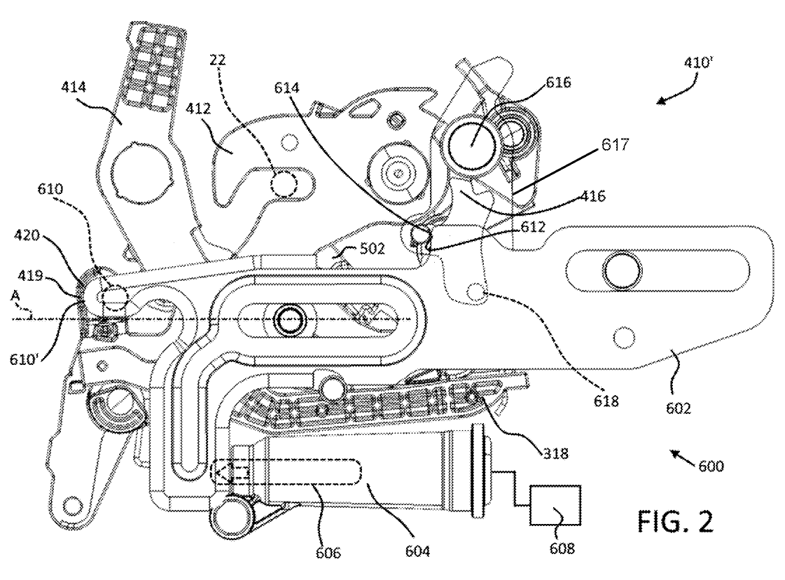

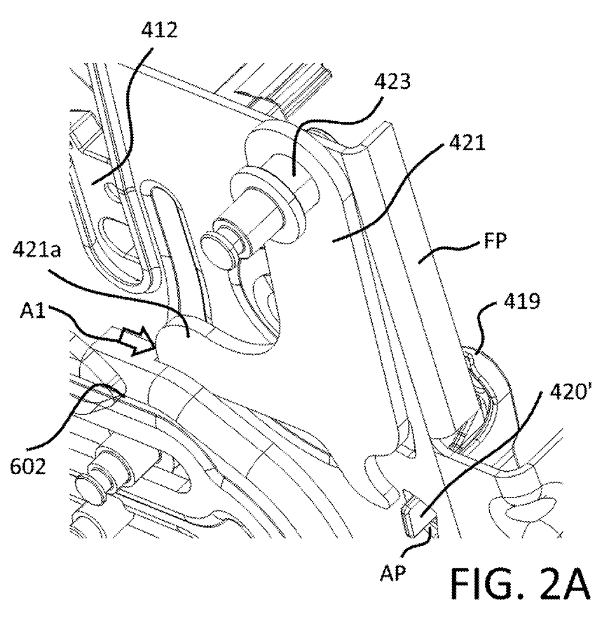

Now referring to FIG. 2, in addition to FIG. 1, there is illustrated another embodiment of a latch 410’ having like elements and components to cinch latch 410, with latch 410 being further enhanced with an active pedestrian mechanism 600 to arrive at latch 410’. Active pedestrian mechanism 600 includes a moveable lever, also referred to as translation member, such as a slider 602, and an actuator, such as a pyrotechnic actuator 604, for moving the slider 602 in translation along an axis A during an active pedestrian protection mode of the latch 410’. Pyrotechnic actuator 604 is activated when a signal is received by the pyrotechnic actuator 604 in response to a sensor, such as a crash sensor 608, detecting the vehicle impact or imminent impact with a pedestrian, such as discussed in co-owned US Appn. Ser. No. 17/576,811, filed on January 14, 2022 and issued as US Pat. No. 11,781,349, the content of which is incorporated herein by way of reference in its entirety. When pyrotechnic actuator 604 is activated by an electrical signal, a plunger 606 will be deployed along or in generally parallel relation to axis A to contact and move the slider 602 along axis A. Slider 602, illustratively, will move from the right side of FIG. 2 toward the left side of FIG. 2 when pyrotechnic actuator 604 is activated and as the slider 602 extends in translation along axis A. Slider 602 includes one or more actuation features that will interact with the pawls of the latch 410’ as the slider 602 is moving along axis A. For example, slider 602 includes a first actuation feature 610, provided as a lug, configured for contacting the auxiliary release lever 419 to move the auxiliary release lever 419, and also includes a second actuation feature 612, illustratively shown as a cam surface, configured for forcible contact with secondary pawl 416 to move the secondary pawl 416 about a pivot axis 616, thereby moving secondary locking surface 334 away from possible engagement with secondary lock surface 344 of ratchet 412. First actuation feature 610 may also be configured as a cam surface 610’ for moving a lug 420 extending from auxiliary release lever 419. In another possible configuration of FIG. 2A, slider 602 may indirectly move release lever 419, and illustratively, slider 602 may act along arrow A1 directly on an intermediate release lever 421, shown as acting on a leg 421a of intermediate release lever 421, whereupon intermediate release lever 421 moves about a pivot axis 423 to act on lug 420’ of auxiliary release lever 419. Lug 420’ is shown extending through an aperture AP of a frame plate FP. The slider 602 is provided on one side of the frame plate FP, and the release lever 419 is provided on the other side of the frame plate FP, wherein the slider 602 and the release lever 419 are coupled to each other using a via aperture AP in the frame plate FP and lug 420’ extending through aperture AP. Illustratively, in FIG. 2, second actuation feature 612, as a cam surface, will indirectly move secondary pawl 416 via contact of a lug 614 on a secondary pawl release lever 617 to move the secondary pawl release lever 617 about the pivot axis 616, thereby moving secondary locking surface 334 away from possible engagement with secondary lock surface 344 of ratchet 412. In another possible embodiment, the second actuation feature 612 may be provided as an extending lug feature 618 extending from the slider 602 to engage with secondary pawl release lever 617.

In operation, pyrotechnic actuator 604 is activated to extend plunger 606 into forcible, driving engagement with slider 602. Plunger 606 will drive translation of the slider 602 along axis A. Slider 602 will act on the auxiliary release lever 419 to cause first drive surface 421 to release the primary locking surface 326 of primary pawl 414 from locking engagement with primary locking surface 342 of ratchet 412 and cause the second drive surface 422 to release the cinching pawl 502 (e.g. to release more than one pawl) from blocking radial alignment and/or blocking engagement with the ratchet 412. Slider 602 will further act on the secondary pawl 416 to radially misalign and/or disengage the secondary pawl 416 with/from the ratchet 412. Slider 602 may also be configured to actuate a lift lever to raise the closure panel and a safety hook (both not shown). As a result, illustratively all the pawls, including primary pawl 414, cinching pawl 502, and secondary pawl 416, are moved to their respective ratchet releasing positions via actuation of pyrotechnic actuator 604 to allow the ratchet 412 to move past the secondary striker capture position to the active pedestrian position.

The foregoing description of the embodiments has been provided for purposes of illustration and description. It is not intended to be exhaustive or to limit the disclosure. Individual elements, assemblies/subassemblies, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A latch for a closure panel of a motor vehicle, comprising:
a ratchet moveable between a primary striker capture position, a secondary striker capture position, and a striker release position; and
at least two pawls aligned with the ratchet to prevent the ratchet from moving to a striker release position, wherein the pawls are moveable away together from the ratchet during an active pedestrian mode of the latch to allow the ratchet to move to an active pedestrian protection position.

2. The latch of claim 1, wherein the at least two pawls includes a primary pawl configured to hold the ratchet in the primary striker capture position, and a secondary pawl configured to hold the ratchet in the secondary striker capture position, wherein the primary pawl and the secondary pawl are moveable away together from the ratchet.

3. The latch of claim 1, wherein the at least two pawls includes a primary pawl configured to hold the ratchet in the primary striker capture position, and a cinching pawl configured to move the ratchet from the secondary striker capture position to the primary striker capture position, wherein the primary pawl and the cinching pawl are movable away together from the ratchet by moving a common release lever during the active pedestrian mode of the latch.

4. The latch of claim 3, wherein the common release lever is an emergency release lever located within a compartment the closure panel closes off.

5. The latch of claim 4, wherein the compartment is a front trunk of a vehicle, and the emergency release lever is accessible from within the front trunk.

6. The latch of claim 1, further including a moveable lever activated by an actuator to cause the at least two pawls to move together to release the ratchet.

7. The latch of claim 6, wherein the moveable lever comprises a slider adapted to directly move a secondary pawl, and directly move an emergency release lever that directly causes movement of a primary pawl and a cinching pawl.

8. The latch of claim 7, wherein the slider is configured to move along a straight axis.

9. The latch of claim 7, wherein the slider is provided on one side of a frame plate of the latch, and the release lever is provided on the other side of the frame plate, wherein the slider and the release lever are operably coupled to each other via a lug extending through an aperture in the frame plate.

10. The latch of claim 1, wherein the at least two pawls includes a primary pawl to hold the ratchet in the primary striker capture position, a secondary pawl to hold the ratchet in the secondary striker capture position, and a cinching pawl that is moveable to engage and move the ratchet from the secondary striker capture position to the primary striker capture position.
